(19) United States
(12) Patent Application Publication
(10) Pub. No.: US 2013/0206271 A1
(43) Pub. Date: Aug. 15, 2013

(54) Exhaust System

(71) Applicant: FAURECIA EMISSIONS CONTROL TECHNOLOGIES, GERMANY GMBH, (US)

(72) Inventors: Helmut Wieser, Aichach (DE); Uwe Troger, Langweld (DE); Muhammad Yasir, Augsburg (DE)

(73) Assignee: FAURECIA EMISSIONS CONTROL TECHNOLOGIES, GERMANY GMBH, Augsburg (DE)

(21) Appl. No.: 13/761,438

(22) Filed: Feb. 7, 2013

(30) Foreign Application Priority Data
Feb. 10, 2012 (DE) 10 2012 002 637.4

(51) Int. Cl. F16L 9/02

(52) U.S. Cl. CPC F16L 9/02
USPC 138/143

(57) ABSTRACT

An exhaust system for motor vehicles has a component made from a coated steel sheet. The steel sheet has a thickness of at most 4.5 mm and is formed of a ferritic stainless steel having a chromium content of from 10.5% to 25%, a molybdenum content of from 0 to 2.5%, and a titanium and/or niobium content of from 0.1 to 2% each. The coating of the steel sheet consists essentially of nickel.

### CROSS-REFERENCE TO RELATED APPLICATION

This application claims priority to DE 10 2012 002 637.4, filed 10 Feb. 2012.

### TECHNICAL FIELD

The invention relates to an exhaust system for motor vehicles including a component made from coated sheet steel.

### BACKGROUND OF THE INVENTION

The components of exhaust systems in motor vehicles are typically produced from high-temperature resistant and corrosion resistant materials such as stainless steel. Typically, such components are manufactured from steels having wall thicknesses of up to 10 mm. The high wall thicknesses are required in order to meet the warranties given by the vehicle manufacturers for the service life of the exhaust systems. For reasons of appearance, the components are often provided with a base layer of nickel and a cover layer of chromium.

Further known is the use of steel sheets that are provided with an aluminum coating. While the steel sheets coated with aluminum are stable against a thermal shock load, they are insufficiently resistant to standing corrosive liquids such as exhaust gas condensates and to crevice corrosion.

U.S. Pat. No. 3,762,884 describes the use of a low-alloy austenitic steel which is coated with a chromium-nickel alloy applied in a flame-spraying process and is subsequently converted to a chromium-containing nickel aluminide layer. The use of austenitic steels involves high alloying costs. Application of the multi-component layer using a flame-spraying method is also expensive and energy-intensive.

Therefore, there exists a continued need for low-cost materials for use in exhaust systems for motor vehicles, which are good to process and suitable for lightweight design applications, but are also resistant to corrosion and to thermal shock.

### SUMMARY OF THE INVENTION

An exhaust system for motor vehicles comprises a component made from a coated steel sheet that has a thickness of at most 4.5 mm, preferably at most 2.5 mm, and is formed of a ferritic stainless steel having a chromium content of from 10.5% to 25%, a molybdenum content of from 0 to 2.5%, a titanium and/or niobium content of 0.1 to 1.2% each, and that the coating consists essentially of nickel.

Ferritic stainless steels are low-priced mass products exhibiting good forming properties and good resistance to corrosion. The nickel coating can be applied onto the sheet steel at low cost known reel-to-reel electroplating systems and likewise exhibits good corrosion resistance to standing liquids such as exhaust gas condensates and to environmental influences. The combination of selected ferritic steels with a nickel coating surprisingly allows the manufacture of cost-efficient but nevertheless mechanically stable components with wall thicknesses suitable for lightweight construction which, nonetheless, satisfy the requirements of motor vehicle manufacturers in regard to the corrosion resistance of exhaust systems within the warranted service life.

Within the meaning of the invention, stainless steel is understood to mean a steel having a carbon content of at most 1.2% and a chromium content of at least 10.5%.

Further, it is understood that the nickel coating is free from other metal elements such as chromium and aluminum, apart from unavoidable impurities, but may contain a minor amount of other non-metallic elements such as carbon, sulfur, phosphorous and boron. Preferably, the nickel coating is obtained by electroplating from electrolyte solutions made from nickel salts and boric acid, and common additives such as ammonium salts, brighteners, complexing agents, levelers, pH adjustors and wetting agents. Typically, the electroplated nickel coating has a purity of at least 98%, preferably at least 99%.

All percentages are based on percent by weight, unless a different reference quantity is indicated.

Since niobium occurs in combination with tantalum and the two elements have identical metallurgical properties and are difficult to separate, for the purposes of the present invention, “niobium” is meant to also include a mixture of niobium and tantalum.

Austenitic steels crystallize in the face-centered cubic crystal lattice and typically have a high nickel content that stabilizes the austenitic structure. Because of the high alloying costs, however, the manufacture of austenitic steels is expensive.

Ferritic steels crystallize in the body-centered cubic crystal lattice and typically exhibit a better resistance to stress corrosion cracking than austenitic steels. An addition of molybdenum further improves the resistance to corrosion and, in addition, stabilizes the ferritic structure. According to the invention, molybdenum-containing ferritic steels are therefore optionally used for producing the coated steel sheets.

The steel sheets used in accordance with the invention furthermore have a content of titanium and/or niobium of 0.1 to 1.2% each. The additions of titanium and/or niobium bind free carbon and bring about a better weldability.

Advantageous embodiments of the invention are indicated in the dependent claims, which may be selectively combined with one another.

In accordance with a preferred embodiment of the exhaust system according to the invention, the steel sheet has a chromium content within the range of from 10.5% to 20%. Above a chromium content of 20%, a transformation to the austenitic crystal structure may appear, in particular at high temperatures.

Particularly preferably, the chromium content is in the range of from 16% to 20% and the molybdenum content amounts to between 0.8% and 2.5%. These steel grades are readily available and are present in a stable state in the ferritic structure, even at the temperatures occurring in exhaust systems.

The carbon content of the steel sheet is preferably in the range of from 0.01 to 0.15%, particularly preferably of from 0.02 to 0.1%. A low carbon content is favorable to the corrosion resistance of the steel sheet.

Preferably, the steel sheet used according to the invention has a titanium and/or niobium content of from 0.1 to 1% each, particularly preferably of from 0.1 to 0.6%. Higher contents of titanium and/or niobium will raise alloying costs but, for the purpose of use in exhaust systems, do not lead to an improvement in properties.

According to a further preferred embodiment, the steel sheet used in accordance with the invention has a relative pitting corrosion resistance, also referred to as Pitting Resistance Equivalent or PRE value, defined as

PRE=% Cr+3*% Mo,

of PRE=10.5−25. The PRE value denotes the relative pitting corrosion resistance of a stainless steel in a chloride-containing environment. The higher the PRE value, the more corrosion-resistant the steel.

The inventors have found that the relative pitting corrosion resistance of the ferritic steel sheet exerts a considerable influence on the behavior of the nickel coating under corrosive conditions. This influence is due to the electrochemical corrosion potential between the nickel coating and the ferritic substrate in the corrosive environment of exhaust systems. With the aid of the PRE value, the nickel-coated steel sheets can therefore be classified as follows:
1) At a PRE value of less than 10.5 the steel substrate can not be considered stainless steel and is therefore not according to the invention.
2) At PRE values of from 10.5 to 17 the steel substrate has a lower electrochemical corrosion potential than the nickel coating. The nickel coating is therefore cathodically protected, and the corrosion will attack the steel substrate. This means that the nickel coating will retain its surface quality over a longer period of time and will remain visually intact. Nickel-coated steel sheets according to the invention that have a PRE value of from 10.5 to 17 are therefore more particularly suitable for use against external corrosion on the visible side of the exhaust system. In this case, the nickel coating preferably has a high tightness to effectively protect the steel substrate against local corrosion.
3) Steel sheets with a PRE value of between 17 and 19 exhibit an electrochemical corrosion potential which roughly corresponds to the corrosion potential of the nickel coating. The nickel coating is therefore no longer cathodically protected and will therefore become discolored more quickly in a corrosive environment. The corrosion attacking at the pores of the steel substrate is not favored by the nickel coating. Therefore, the requirements made on the tightness of the nickel coating may be lower than in the case of stainless steel substrates having PRE values of below 17.
4) In the case of steel sheets with a PRE value as of 19 and higher, the electrochemical corrosion potential is lower than the corrosion potential of the nickel coating. The corrosion will therefore attack the nickel coating, which will become discolored more quickly under the corrosive conditions of an exhaust system. The steel substrate, on the other hand, is cathodically protected by the nickel coating. Therefore, for applications on the visible side of the exhaust system, an additional passivation of the nickel layer may be effected.

The nickel-coated steel sheets according to the invention are suitable in particular for lightweight design applications in the area of exhaust systems. The steel sheet formed from the ferritic stainless steel according to the invention therefore preferably has a thickness of from 0.4 to 2.5 mm. Sheets having thicknesses of less than 0.4 mm are, in most cases, too instable and difficult to process. Components made of sheet steel with thicknesses of more than 2.5 mm are less preferred due to the higher weight, and components made of sheet steel with wall thicknesses of more than 4.5 mm are too heavy.

Particularly preferably, the steel sheet has a thickness of from 0.4 to 1.2 mm. It has turned out that even the steel sheets according to the invention having a thickness of up to 1.2 mm can still be made use of for producing mechanically stable exhaust system components which are protected from corrosion over the warranted service life. The use of components having such low wall thicknesses results in a considerable weight saving and, hence, in lower fuel consumption. In addition, the cost of materials in the manufacture of the exhaust systems is also lower.

The nickel coating is preferably applied by electrodeposition on the steel sheet. The deposition in electroplating baths is technically proven and can be carried out rapidly and at low cost in particular on reel-to-reel electroplating lines with the desired tightness.

According to a preferred embodiment, the nickel coating on the steel sheet comprises one or more layers of nickel with an overall thickness of between 3 and 20 μm. Layer thicknesses of less than 3 μm are often not sufficiently tight and tend to corrode locally. Layer thicknesses of more than 20 μm are too expensive.

The nickel-coated steel sheet can be processed without any further thermal treatment. Alternatively, a diffusion treatment may be performed additionally, as is generally known in the prior art. The diffusion treatment causes, for one thing, the adhesion of the nickel coating to be improved and, for another, the density of the layer and, hence, the resistance to local corrosion to be increased.

The phosphorus content in the at least one electrodeposited nickel layer preferably amounts to at most 1%, particularly preferably at most 0.5%. Nickel layers having higher phosphorus contents are usually too soft and may fail with the mechanical and thermal loads occurring in an exhaust system.

A further subject matter of the invention is the use of a nickel-coated steel sheet according to any of the above-mentioned embodiments as a component in an exhaust system for a motor vehicle, the steel sheet having a thickness of at most 4.5 mm, preferably at most 2.5 mm, and is formed of a ferritic stainless steel having a chromium content of from 10.5% to 25%, a molybdenum content of from 0 to 2.5%, and a titanium and/or niobium content of from 0.1 to 1.2% each.

According to a preferred embodiment, the component is part of an exhaust pipe, an exhaust tube, part of a muffler, or a housing of an exhaust gas treatment device, in particular of a catalytic converter or of a diesel particulate filter. These components may be exposed to temperatures of up to about 900° C., depending on the application.

Particularly preferably, the component made from the nickel-coated steel sheet is arranged within an area of the exhaust system in which condensates form from constituents of the exhaust gas. In this case, the nickel coating faces the corrosive condensates. Any local corrosion and/or corrosion by standing liquids can then be prevented in an optimum manner in these areas.

### BRIEF DESCRIPTION OF THE DRAWINGS

The invention will now be described below with reference to a preferred exemplary embodiment and the accompanying drawing, in which:

FIG. 1 shows a schematic view of an internal combustion engine of a motor vehicle, including an exhaust system according to the invention.

### DETAILED DESCRIPTION

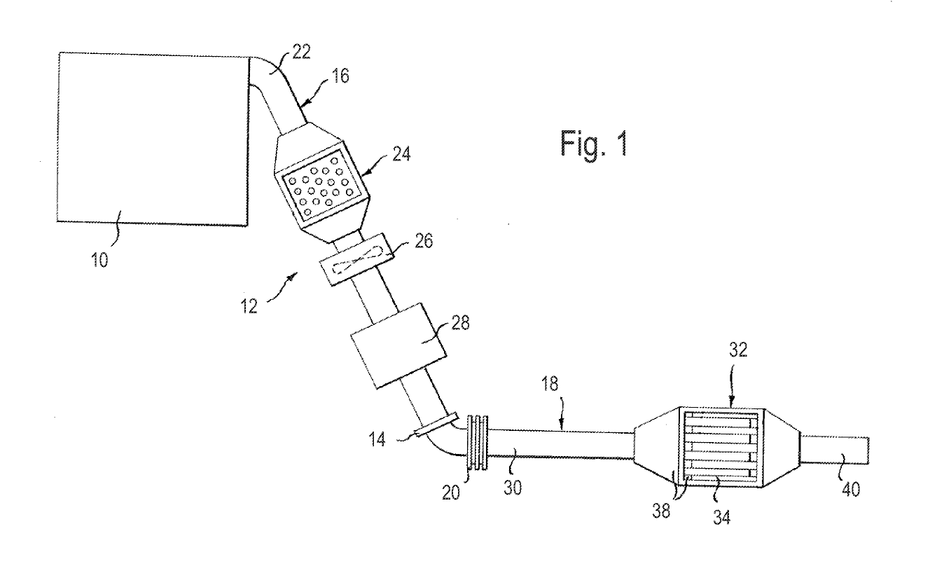

FIG. 1 illustrates, by way of example, the internal combustion engine 10 of a motor vehicle and an exhaust system 12 arranged downstream. The exhaust system 12 has a manifold section 16 extending as far as to a flange 14, and an underbody section 18 adjoining the manifold section 16 downstream, which are connected with each other by a vibration decoupler 20.

The internal combustion engine 10 is adjoined by an exhaust pipe having a first tube section 22 which leads to a particulate receiving accumulator 24 with an oxidation catalytic converter.

Immediately downstream of the particulate receiving accumulator 24, a turbocharger 26 is seated in the manifold section 16. Alternatively, the positions of the particulate receiving accumulator 24 and of the turbocharger 26 may also be exchanged. Likewise arranged in the manifold section 16, more specifically downstream of the particulate receiving accumulator 24 and the turbocharger 26, is a NOₓ storage 28.

The underbody section 18 comprises an elongated exhaust gas pipe 30 which leads to a particulate filter unit 32. The particulate filter unit 32 may be a common soot filter, having a substrate or filter insert 34 of cordierite and an oxidation catalytic converter 38 arranged upstream. The oxidation catalytic converter 38 may be dispensed with if the upstream part of the filter insert 34 is appropriately coated. The particulate filter unit 32 is adjoined by a tube section 40 which leads to a muffler (not shown) and discharges the exhaust gases.

The components described here of the exhaust system are known as such in the prior art and may vary depending on the type of fuel used and the area of application of the exhaust system.

All the components of the exhaust system are exposed to high temperatures which are far above 250° C. and may reach up to 900° C. Due to temperature fluctuations during the operation of the exhaust system, considerable alternating loads appear at the components. Furthermore, at colder points of the exhaust system, the formation of highly corrosive condensates from the constituents of the exhaust gas can be observed.

In addition, the visible side of the exhaust system is also constantly exposed to a corrosive environment during operation of a motor vehicle, for example by the action of road salt during the winter months.

The components of the exhaust system are therefore required to resist a corrosion at least over the service life as warranted by the vehicle manufacturer. But at the same time there is a demand for lower vehicle weight in order to reduce fuel consumption.

Therefore, individual or several components of the exhaust system 12, in particular parts of the exhaust pipe such as the exhaust tubes 22 and 30, part of the muffler, or the housings of an exhaust gas treatment device, in particular of the oxidation catalytic converter 38 or of the particulate filter units 24 and 32, are formed of a steel sheet coated with nickel, the steel sheet having a thickness of at most 2.5 mm and being formed of a ferritic stainless steel having a chromium content of from 10.5% to 25%, a molybdenum content of from 0 to 2.5%, and a titanium and/or niobium content of from 0.1 to 1.2% each.

As to the classification of steel grades, reference is made to DIN EN 10020: 2007-03.

The nickel coating may be applied onto the steel sheet in the form of one or more layers with the desired tightness at low cost by known reel-to-reel electroplating systems, and surprisingly exhibits a good corrosion resistance both to standing liquids such as condensates and to environmental influences.

For the nickel coating, electroplating baths may be used as are known in the prior art. Suitable electroplating baths are, for example, baths with nickel salts, in particular nickel sulfate and nickel chloride in an acid solution (pH 4 to 5), in particular in boric acid.

According to a preferred embodiment, the ferritic steel sheet has a chromium content in the range of from 10.5% to 20%. As an example of such a steel, grade 1.4512 may be mentioned.

Particularly preferably, the chromium content is in the range of from 16% to 20% and the molybdenum content amounts to between 0.8% and 2.5%. Grades 1.4526 and 1.4513 are examples of such steels.

The carbon content of the steel sheet is preferably in the range of from 0.01 to 0.15%, particularly preferably from 0.02 to 0.08%.

In the embodiments described above, the steel sheet used in accordance with the invention preferably has a titanium and/or niobium content of from 0.1 to 1% each, particularly preferably of from 0.1 to 0.6% each.

According to a particularly preferred embodiment, the steel sheet used in accordance with the invention has a relative pitting corrosion resistance (PRE value), defined as PRE=% Cr+3*% Mo, of from 10.5 up to and including 25, preferably from 10.5 to about 19. In this range of the PRE values, the nickel coating is either cathodically protected and will remain visually intact, or the corrosion at the steel substrate is not affected adversely by the nickel coating.

According to an even more particularly preferred embodiment, the steel sheet formed of the ferritic stainless steel in accordance with the invention has a thickness of from 0.4 to 1.2 mm.

Preferably, the steel sheets are provided with the nickel coating on both sides. For cost efficiency, however, the nickel coating may in all embodiments be only applied on that side of the steel sheet that is exposed to an attack by corrosion in the exhaust system in the installed condition.

Using known forming techniques and/or welding methods, the nickel-coated steel sheet can be processed to form the components of the exhaust system, without any further thermal treatment.

According to a further embodiment, a diffusion treatment may be additionally carried out, as is generally known in the prior art. The diffusion treatment, for one thing, causes the adhesion of the nickel coating to be improved and, for another thing, the density of the layer and, thus, the resistance to local corrosion to be increased.

The components made of the steel sheet coated with nickel are preferably arranged in an area within the exhaust system in which condensates form from constituents of the exhaust gas. Any local corrosion and/or corrosion by standing liquids can then be reduced in an optimum manner in these areas.

Study Of Artificial Aging in the Salt Spray Test

For testing the corrosion resistance of sheet steel coated with nickel in accordance with the invention, in comparison with uncoated steel sheets, an artificial aging test was performed. For this purpose, different test specimens having dimensions of 100 mm×100 mm were at first held at room temperature or heated to temperatures of between 300° C. and 500° C. for 3.5 hours, and were subsequently sprayed with a sodium chloride solution (5 wt.-% NaCl in distilled water) for 4 hours. Then the test specimens were subjected to an alternating condensation atmosphere between 20° C. and 40° C. and an air humidity of between 70 and 95% for 4 hours. Subsequently, an indoor climate at 20° C. and an air humidity of 65% was simulated for 12.5 hours. This four-part treatment cycle was repeated several times. The test specimens were then visually inspected for corrosion sites.

The aging test described corresponds to a loading of the components of an exhaust system under normal operating conditions over a time period of about 4 years.

Three steel sheets of ferritic stainless steels of the grades 1.4510, 1.4512, and 1.4509 (DIN EN 10088-2) and one uncoated steel sheet of an austenitic stainless steel of the grade 1.4301 (DIN EN 10088-2; AISI 304) were tested, each of which was coated with nickel in a reel-to-reel electroplating line. The overall thickness of the nickel layer amounted to between about 3 and 10 μm.

The results of the salt spray test are indicated in the Table below.

TABLE

| Sample | room temperature | 300° C. | 400° C. | 500° C. |
|---|---|---|---|---|
| Ni-1.4510 | + | + | + | + |
| Ni-1.4512 | + | + | + | + |
| Ni-1.4509 | + | + | + | + |
| 1.4301 | + | +/− | − | − |
| (comparison) | | | | |

In the Table,
+ means low corrosion; usable
+/− means clearly visible corrosion; usable to a limited extent
− means heavy corrosion; unusable
It can be shown by means of the aging test described above that the steel sheets coated with nickel according to the invention exhibit a sufficient resistance to corrosion and are suitable for lightweight design applications in exhaust systems.

Although an embodiment of this invention has been disclosed, a worker of ordinary skill in this art would recognize that certain modifications would come within the scope of this invention. For that reason, the following claims should be studied to determine the true scope and content of this invention.

1. An exhaust system for motor vehicles, comprising:
a component made from a coated steel sheet, wherein the coated steel sheet has a thickness of at most 4.5 mm and is formed of a ferritic stainless steel having a chromium content of from 10.5% to 25%, a molybdenum content of from 0 to 2.5%, a titanium and/or niobium content of from 0.1 to 1.2% each, and the coating consisting essentially of nickel.

2. The exhaust system according to claim 1, wherein the steel sheet has a chromium content in the range of from 10.5% to 20%.

3. The exhaust system according to claim 1, wherein the coated steel sheet has a chromium content in the range of from 16% to 20% and a molybdenum content of from 0.8% to 2.5%.

4. The exhaust system according to claim 1, wherein the coated steel sheet has a titanium and/or niobium content of from 0.1 to 0.6% each.

5. The exhaust system according to claim 1, wherein the coated steel sheet has a carbon content in the range of from 0.01 to 0.15%.

6. The exhaust system according to claim 1, wherein the coated steel sheet has a pitting resistance, defined as PRE=% Cr+3*% Mo, of PRE=10−25.

7. The exhaust system according to claim 1, wherein the coated steel sheet has a thickness of from 0.4 to 2.5 mm.

8. The exhaust system according to claim 1, wherein the steel sheet has a thickness of at most 2.5 mm, in particular of from 0.4 to 1.2 mm.

9. The exhaust system according to claim 1, wherein the nickel coating includes one or more layers of nickel having an overall thickness of the coating of between 3 μm and 20 μm.

10. The exhaust system according to claim 1, wherein the phosphorus content in the nickel coating amounts to at most 1%.

11. The exhaust system according to claim 1, wherein the nickel-coated steel sheet is diffusion-treated.

12. The exhaust system according to claim 1, wherein the coating is electroplated nickel.

13. A method of operating an exhaust system for motor vehicles comprising the steps of:
making a component from a steel sheet that has a thickness of at most 4.5 mm, in particular at most 2.5 mm, and is formed of a ferritic stainless steel having a chromium content of from 10.5% to 25%, a molybdenum content of from 0 to 2.5%, and a titanium and/or niobium content of from 0.1 to 1.2% each, and wherein the steel sheet has a coating consisting essentially of nickel.

14. The method according to claim 12, including using the component as part of an exhaust pipe, an exhaust tube, part of a muffler, or a housing of an exhaust gas treatment device, in particular of a catalytic converter or of a diesel particulate filter.

15. The method according to claim 12, including arranging the steel sheet inside the exhaust system such that the steel sheet is exposed to corrosion by standing liquids, the nickel coating facing the standing liquid.

16. The method according to claim 13, wherein the coating is electroplated nickel.
